(19) United States
(12) Patent Application Publication
(10) Pub. No.: US 2025/0145072 A1
(43) Pub. Date: May 8, 2025

(54) Rear Lift Sensing System

(71) Applicant: Harmar Mobility, LLC, Sarasota, FL (US)

(72) Inventors: Jeffrey Dale Limbaugh, Parrish, FL (US); Alan Philip Seidel, Gainesville, FL (US); David Russell Baxter, Sarasota, FL (US)

(73) Assignee: Harmar Mobility, LLC, Sarasota, FL (US)

(21) Appl. No.: 18/939,473

(22) Filed: Nov. 6, 2024

Related U.S. Application Data
(60) Provisional application No. 63/547,545, filed on Nov. 6, 2023.

(51) Int. Cl. B60P 1/44; A61G 3/06

(52) U.S. Cl. CPC B60P 1/4421; A61G 3/062; B60P 1/4478; B60Y 2400/3015

(57) ABSTRACT

A rear sensing system engaged with a lift system. The rear sensing system includes a first sensing system to display information from the sensing system when the lift system is in the up position and a second sensing system to display information from the sensing system when the lift is in the down position.

### CROSS-REFERENCE TO RELATED APPLICATIONS

This application claims priority to U.S. Provisional Patent Application No. 63/547,545 titled “Rear Lift Sensing System” filed on Nov. 6, 2023, which is incorporated by reference herein in its entirety.

### TECHNICAL FIELD

This disclosure relates to a lift system designed to connect to the rear of an automobile, such as the automobile hitch, and designed to carry a personal mobility vehicle such as a wheelchair, scooter, power wheelchair, bike/e-bike, and/or similar device. More particularly, this disclosure relates to systems for vision and/or sensing engaged with such a lift system.

### BACKGROUND

Many lift systems exist that are designed to carry a personal mobility vehicle such as a wheelchair, scooter, power wheelchair, bike/e-bike, and/or similar device on the rear of an automobile. This disclosure relates primarily to vision and/or sensor systems engaged with the lift system to allow a user to more easily operate the automobile while the lift system is connected to the automobile.

### SUMMARY

The following summary presents a general overview of various aspects of the present disclosures. This summary is not an extensive description of all aspects of the present disclosures and should not be understood to identify key or critical elements.

In one aspect, this disclosure provides a lift system configured to engage with a rear portion of an automobile. The lift system includes a lift tower; a platform which can be moved between an up position and a down position; a first sensor housing engaged with the platform, the first sensor housing including a first camera; a second sensor housing engaged with the platform, the second sensor housing including a second camera; a display screen configured to display images from the first camera and the second camera; and a switch, the switch configured to switch an image displayed on the display screen between the first camera when the platform is in the up position and the second camera when the platform is in the down position. The first sensor housing may be manually rotated to a first angle and the second sensor housing may be manually rotated to a second angle such that when the platform is in the up position the first camera is directed substantially rearward, and when the platform is in the down position the second camera is directed substantially rearward.

The lift system may also include a sensor system housing configured to engage both of the first sensor housing and the second sensor housing. The first sensor housing may be rotatably engaged with the sensor system housing. The second sensor housing may be rotatably engaged with the sensor system housing. The first sensor housing may be adjacent the second sensor housing. The switch may be a mercury switch, a gyroscope switch, or an accelerometer.

The first sensor housing may also include a first proximity sensor, and the second sensor housing may include a second proximity sensor.

In another aspect, this disclosure provides a lift system configured to engage with a rear portion of an automobile. The lift system includes a lift tower; a platform which can be moved between an up position and a down position; a first sensor housing engaged with the platform, the first sensor housing including a first camera; and a first proximity sensor; a second sensor housing engaged with the platform, the second sensor housing including a second camera; and a second proximity sensor; a display screen configured to display images from the first camera and the second camera; and a switch, the switch configured to switch an image displayed on the display screen between the first camera and first proximity sensor when the platform is in the up position and the second camera and second proximity sensor when the platform is in the down position. The first sensor housing and the second sensor housing may be rotated such that when the platform is in the up position the first camera and the first proximity sensor are directed substantially rearward, and when the platform is in the down position the second camera and the second proximity sensor are directed substantially rearward.

The lift system may also include a sensor system housing configured to engage both of the first sensor housing and the second sensor housing. The first sensor housing may be rotatably engaged with the sensor system housing. The second sensor housing may be rotatably engaged with the sensor system housing. The first sensor housing may be adjacent the second sensor housing.

In another aspect, this disclosure provides a lift system configured to engage with a rear portion of an automobile. The lift system includes a lift tower; a platform which can be moved between an up position and a down position; a sensor system housing engaged with a rear edge of the platform; a first camera engaged with the sensor system housing; a second camera engaged with the sensor system housing; a display screen configured to display images from the first camera and the second camera; and a switch, the switch configured to switch an image displayed on the display screen between the first camera when the platform is in the up position and the second camera when the platform is in the down position. The first camera is directed to a first angle and the second camera is directed to a second angle such that when the platform is in the up position the first camera is directed substantially rearward, and when the platform is in the down position the second camera is directed substantially rearward. The first camera may be adjacent to the second camera. The lift system may also include at least one proximity sensor engaged with the sensor system housing. The first camera and the second camera may each be rotatably engaged with the sensor system housing.

### DESCRIPTION OF THE DRAWINGS

To allow for a more full understanding of the present disclosure, it will now be described by way of example, with reference to the accompanying drawings in which:

FIG. 1 illustrates a back view of an exemplary lift system in a down position, in accordance with aspects of the disclosure;

FIG. 1A illustrates detail A of FIG. 1 showing a rear sensing system, in accordance with aspects of the disclosure;

FIG. 2 illustrates a back perspective view of an exemplary lift system in an up position accordance with aspects of the disclosure;

FIG. 3 illustrates a back view of an exemplary lift system in an up position accordance with aspects of the disclosure;

FIG. 4 illustrates a side view of an exemplary lift system in an up position accordance with aspects of the disclosure;

FIG. 5 illustrates a side view of an exemplary lift system in a down position accordance with aspects of the disclosure;

FIG. 6 illustrates a back view of an exemplary lift system in a down position, in accordance with aspects of the disclosure;

FIG. 6A illustrates detail A of FIG. 6 showing a rear sensing system, in accordance with aspects of the disclosure;

FIG. 7 illustrates a back perspective view of an exemplary lift system in an up position accordance with aspects of the disclosure;

FIG. 8 illustrates a back view of an exemplary lift system in an up position accordance with aspects of the disclosure;

FIG. 9 illustrates a side view of an exemplary lift system in an up position accordance with aspects of the disclosure;

FIG. 10 illustrates a side view of an exemplary lift system in a down position accordance with aspects of the disclosure;

FIG. 11 illustrates a schematic view of a sensing and display system, in accordance with aspects of the disclosure;

FIG. 12 illustrates a schematic view of a sensing and display system, in accordance with aspects of the disclosure;

FIG. 13 illustrates a schematic view of a sensing and display system, in accordance with aspects of the disclosure;

FIG. 14 illustrates a perspective view of an exemplary display system, in accordance with aspects of the disclosure; and

FIG. 15 illustrates a perspective view of an exemplary display system, in accordance with aspects of the disclosure.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “top,” “bottom,” “front,” “back,” “side,” “distal,” and the like may be used in this specification to describe various example features and elements of the invention, these terms are used herein as a matter of convenience, e.g., based on the example orientations shown in the figures or the orientation during typical use. Nothing in this specification should be construed as requiring a specific three-dimensional orientation of structures in order to fall within the scope of this invention. Also, the reader is advised that the attached drawings are not necessarily drawn to scale.

The following terms are used in this specification, and unless otherwise noted or clear from the context, these terms have the meanings provided below.

“Plurality,” as used herein, indicates any number greater than one, either disjunctively or conjunctively, as necessary, up to an infinite number.

In general, this disclosure relates to a lift system attached to an automobile that is configured to carry a personal mobility device. The mobility device can include vehicles such as a wheelchair, scooter, power wheelchair, bike/e-bike, and/or similar device. More particularly, this disclosure relates to lift sensing systems engaged with such a lift system.

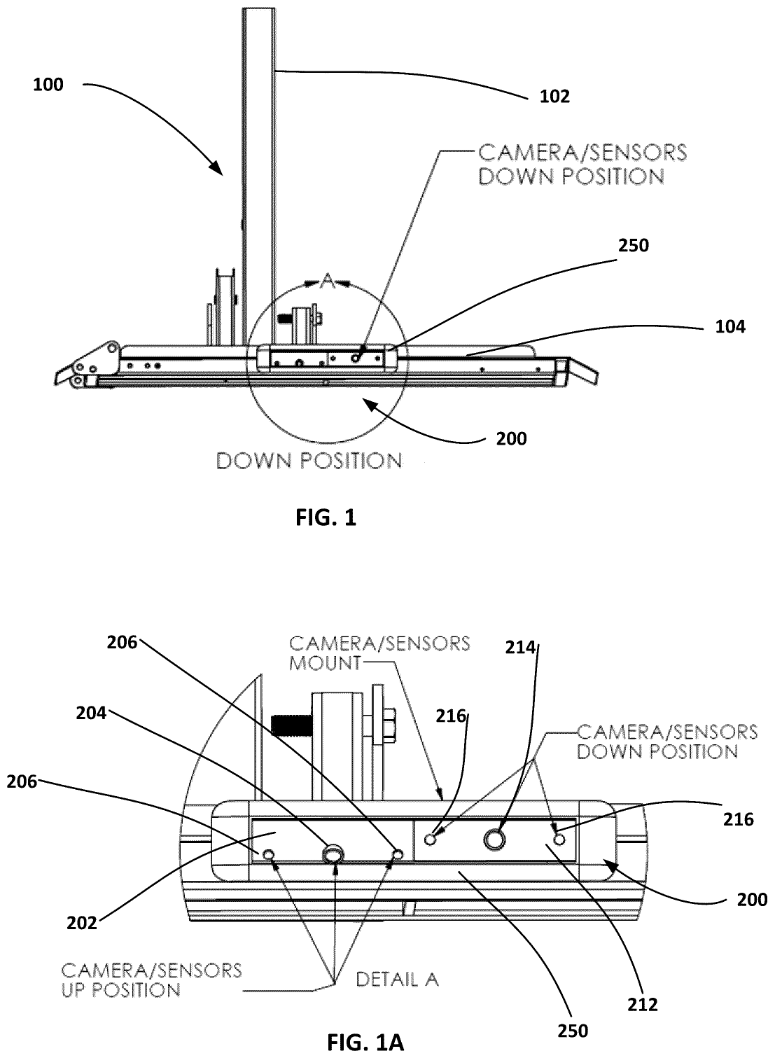

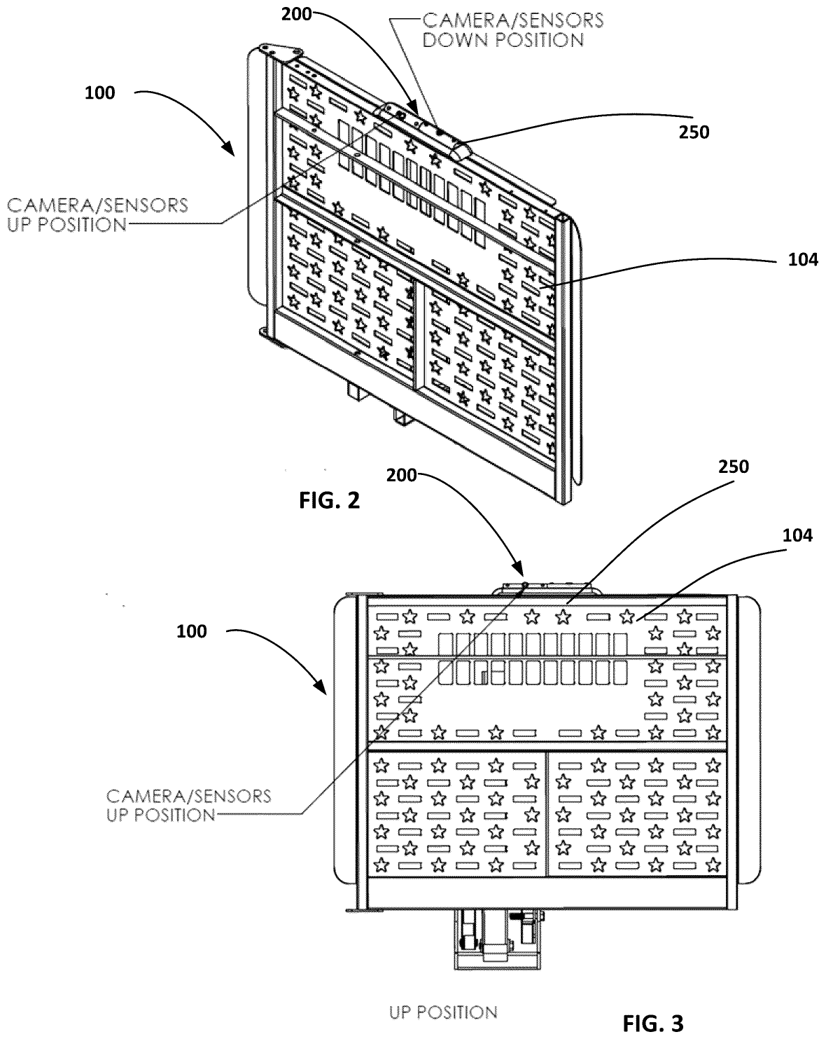

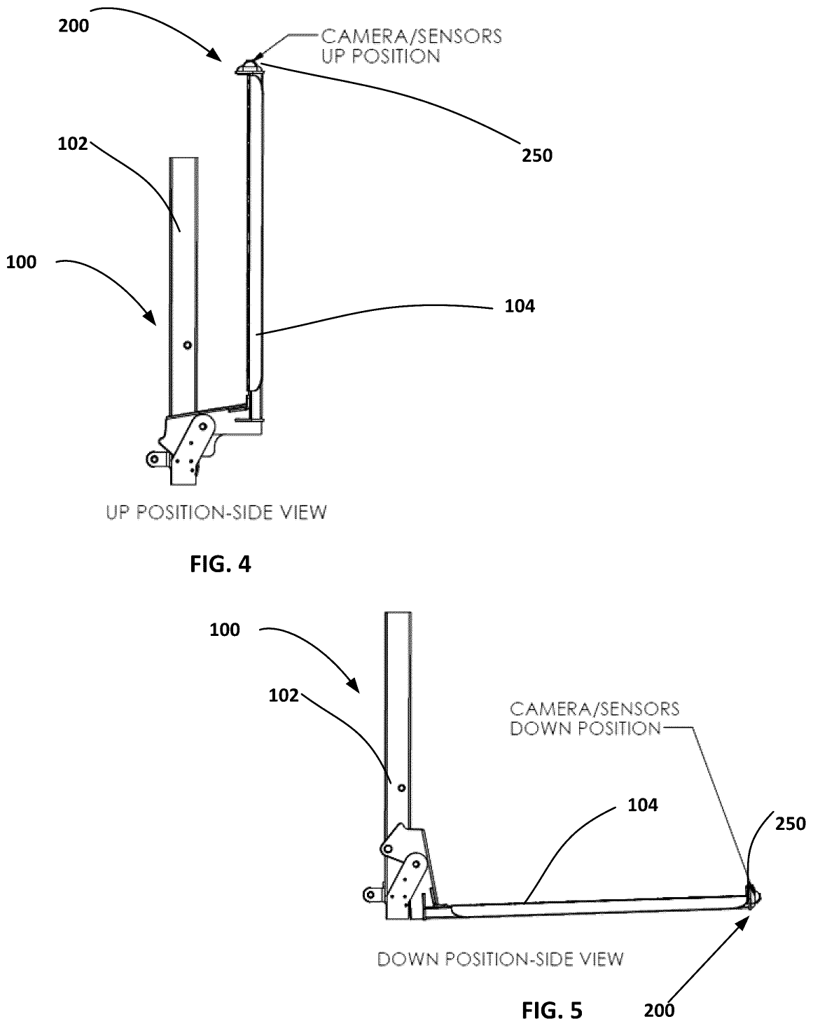

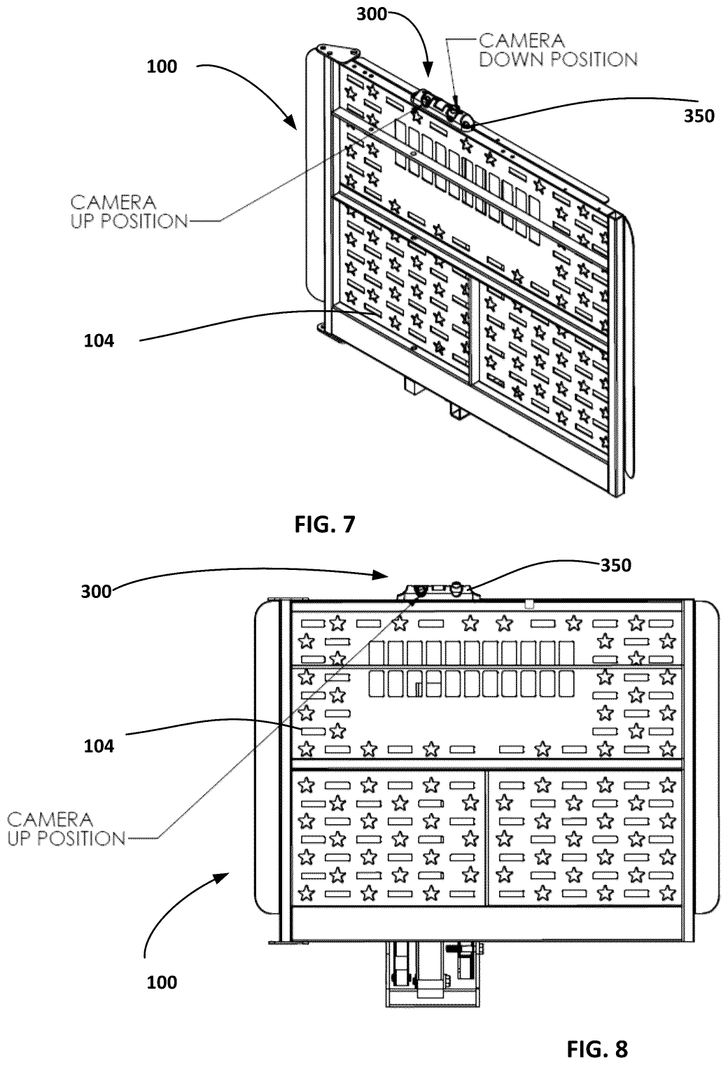

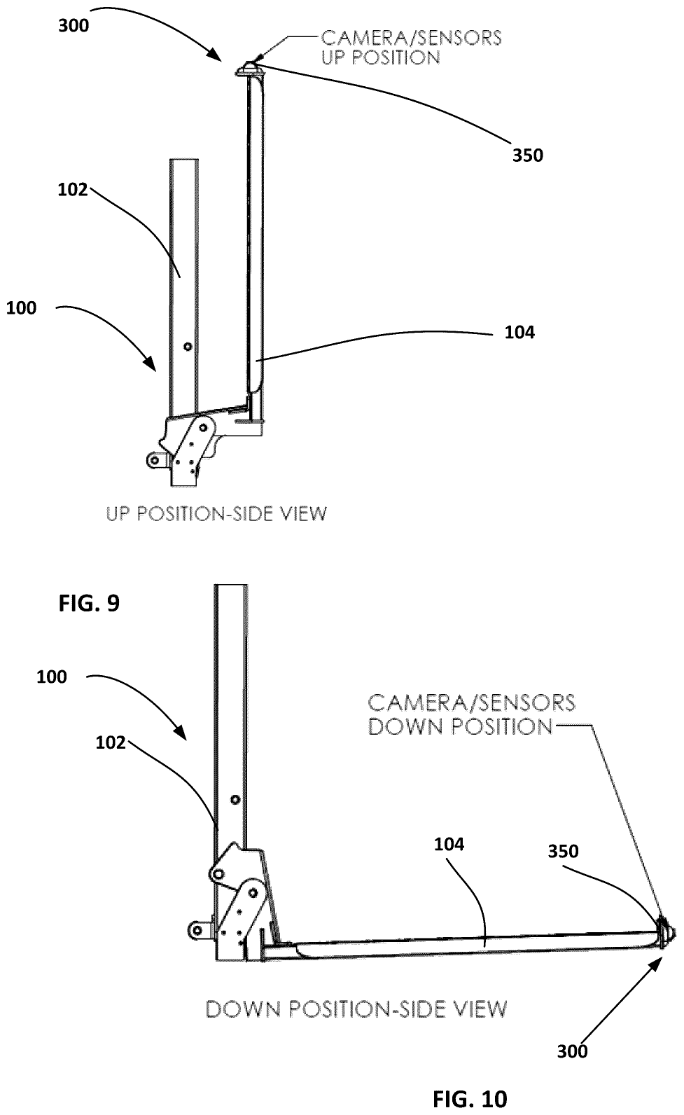

FIGS. 1-15 illustrate aspects of a rear lift sensing system. As shown primarily in FIGS. 1-5, the lift system 100 can include a lift tower 102 engaged with a lift platform 104. As will be understood by one of skill in the art, the platform 104 can be moved between an up position (shown in FIG. 4) and a down position (shown in FIG. 5). In the up position the platform is substantially vertical and is stowed, or not being used to hold a mobility vehicle. In the down position, the platform is substantially horizontal and in this position the platform is active or can be used to hold a mobility vehicle. When the platform 104 is in the down position it may be used to support a personal mobility vehicle such as a wheelchair, scooter, power wheelchair, bike/e-bike, and/or similar device. Additionally, the platform 104 may also be lowered to a lowered position wherein the personal mobility vehicle may be more easily loaded or driven onto the platform 104. The movement of the lift between the down position and the lowered position may be accomplished by a lifting device such as a drive screw or other suitable device. As shown in FIGS. 1-5, a drive screw may be located within the lift tower 102. Movement of the platform between the up position and the down position may be accomplished by a suitable lifting device or the platform could be manually movable. Exemplary lift systems are described in U.S. Pat. Nos. 10,457,187; 11,007,919; 7,686,562; and 6,837,666 which are incorporated by reference herein.

The lift system 100 can also include a sensing system 200. The sensing system 200 can include a sensor system housing 250 configured to engage the platform 104. The sensor housing 250 can further include a first sensor housing 202 and a second sensor housing 212. The first sensor housing 202 can include a first camera 204 and at least a first proximity sensor 206. However, as shown in the figures, the first sensor housing 202 may include two proximity sensors 206 or a plurality of proximity sensors 206. The sensor housing 250 can also include a second sensor housing 212 which can include a second camera 214 and a second proximity sensor 216. However, as shown in the figures, the second sensor housing 212 includes two proximity sensors 216 or a plurality of proximity sensors 216. In some embodiments the first sensor housing 202 and second sensor housing 212 may be larger than shown in FIG. 1 and may extend the length of the back edge of the platform 104. This may allow for the proximity sensors 206, 216 to be spaced further apart and may provide increased accuracy. Advantageously, the first sensor housing 202 and the second sensor 212 housing may be movable such that when the platform 104 is in the up position the first camera 204 and the first proximity sensor 206 may be directed substantially rearward; and when the platform 104 is in the down position, the second camera 214 and the second proximity sensor 216 may be directed substantially rearward. This allows a user of the automobile to use a camera and a proximity sensor when the platform is in either the up position or the down position. In some examples, the first sensor housing 202 and the second sensor housing may be rotatable. In some examples, the movement of the first sensor housing 202 and the second sensor housing may be manually controlled or it may be electronically controlled. The first sensor housing 202 and the second sensor housing 204 may be adjacent each other within the sensor system housing 250. Further the first sensor housing 202 can be rotatably engaged with the sensor system housing 250 and the second sensor housing 212 can be rotatably engaged with the sensor system housing 250. In one example, the first sensor housing 202 may be manually rotated to a first angle such that the first camera 204 is directed rearward when the platform 104 is in the up position. And the second sensor housing 212 may be manually rotated to a second angle, which is different than the first angle, such that the second camera 214 is directed rearward when the platform 104 is in the down position. Once the first sensor housing 202 is rotated to the first angle and the second sensor housing 212 is rotated to the second angle, the sensor housings 202, 204 may be locked in position. Advantageously, such a manual adjustment system may allow for the platform and sensor system to be used on multiple different vehicles. In other embodiments, the first sensor housing 202, and second sensor housing 212, or first camera 204 and second camera 214 may be installed within the sensor system housing 250 such that they are not movable. In such a configuration the first sensor housing 202 and/or first camera 2014 may be directed at a first angle and the second sensor housing 212 and/or second camera 214 may be directed at a second angle.

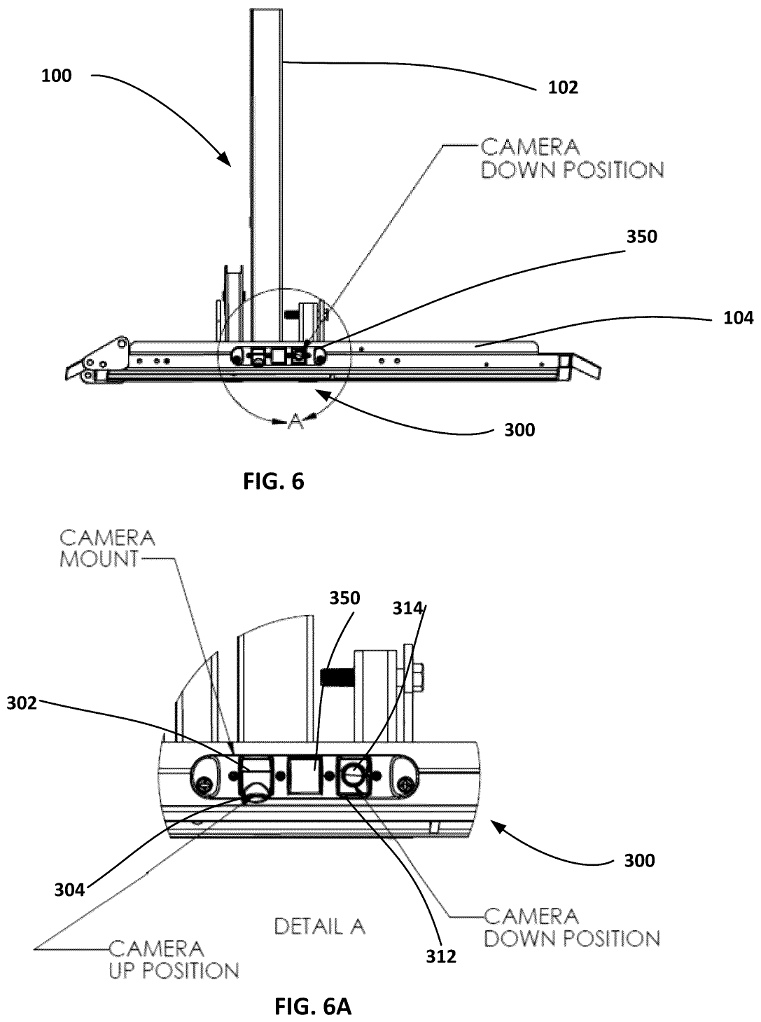

FIGS. 6-10 display another embodiment of the lift system 100 having a sensing system 300. The sensing system 300 is similar to the sensing system 200 discussed above, except it may have fewer or no proximity sensors. The sensing system 300 is shown in FIGS. 6-10 wherein similar parts to the sensing system 200 or labeled using 300 series reference numerals. The sensing system 300 can include a sensor system housing 350 configured to engage the platform 104. As shown in FIG. 8, the housing 350 may be substantially centered on the center of the vehicle, which may not correspond to the center of the platform 104. The sensor housing 350 can further include a first sensor housing 302 and a second sensor housing 312. The first sensor housing 302 can include a first camera 304 and at least a first proximity sensor 306. Advantageously, the first sensor housing 302 and the second sensor 312 housing may be movable such that when the platform 104 is in the up position the first camera 304 may be directed substantially rearward; and when the platform 104 is in the down position, the second camera 314 may be directed substantially rearward. This allows a user of the automobile to use a camera in either the up position or the down position. In some examples, the first sensor housing 302 and the second sensor housing 312 may be rotatable. In some examples, the movement of the first sensor housing 302 and the second sensor housing 312 may be manually controlled or it may be electronically controlled. The first sensor housing 302 and the second sensor housing 312 may be adjacent each other within the sensor system housing 350. Further the first sensor housing 302 can be rotatably engaged with the sensor system housing 350 and the second sensor housing 312 can be rotatably engaged with the sensor system housing 350. In one example, the first sensor housing 302 may be manually rotated to a first angle such that the first camera 304 is directed rearward when the platform 104 is in the up position. And the second sensor housing 312 may be manually rotated to a second angle, which is different than the first angle, such that the second camera 314 is directed rearward when the platform 104 is in the down position. Once the first sensor housing 302 is rotated to the first angle and the second sensor housing 312 is rotated to the second angle, the sensor housings 302, 304 may be locked in position. Advantageously, such a manual adjustment system may allow for the platform and sensor system to be used on multiple different vehicles.

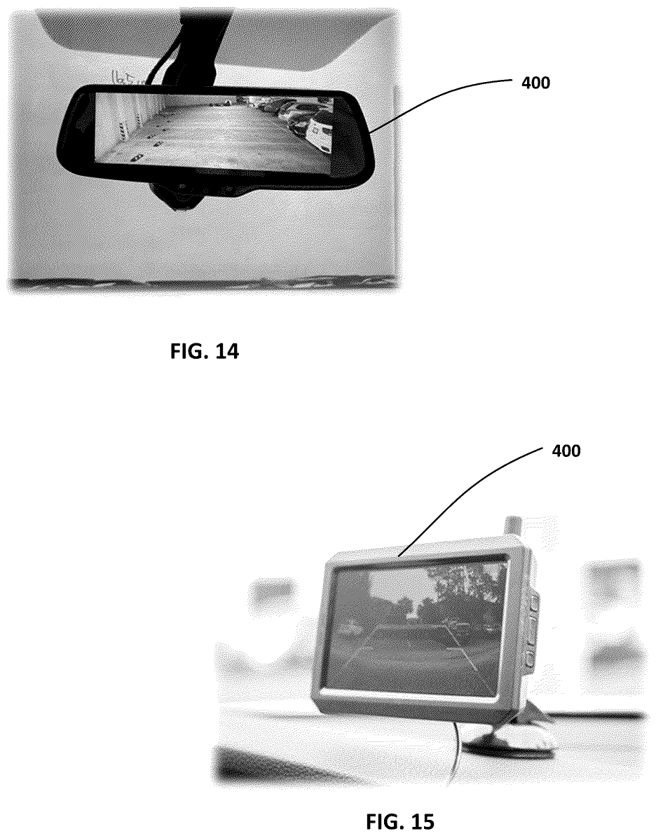

The lift sensing system 200, 300 can also include a display screen 400 configured to display the image from the first camera 204, 304 and the second camera 214, 314. The display screen may also be configured to display a visual and/or audible alert if the proximity sensor senses that something is too close to the lift 100. In some embodiments, the display screen may be configured to only display an image from the first and/or second camera when the automobile is in reverse. The display systems can consist of an LCD monitor or other similar device. In some examples, the display screen can be incorporated into the rearview mirror of an automobile as shown in FIG. 14. In other embodiments the display screen 400 can be a screen which can be mounted inside the automobile, such as on the dashboard as shown in FIG. 15. In still other embodiments, the sensing system 200, 300 can be connected to a display screen 400 that can be a preexisting screen that may already be included in the automobile.

The lift sensing system 200, 300 can also include a switch 402 configured to switch the display screen to show the image from the first camera 204, 304, when the platform is in the up position, or the second camera 214, 314, when the platform is in the down position. The switch may be a positional switch, such as a mercury switch, gyroscope switch, accelerometer, or any other type of suitable switch. The switch 402 may be included within the housing 250, 350 or may be located on a different portion of the lift 100. The switch 402 senses the lift position and can send power to the corresponding first camera 204, 304 and first proximity sensor 206 (when the platform is in the up position) or second camera 214, 314 and second proximity sensor 216 (when the platform is in the down position).

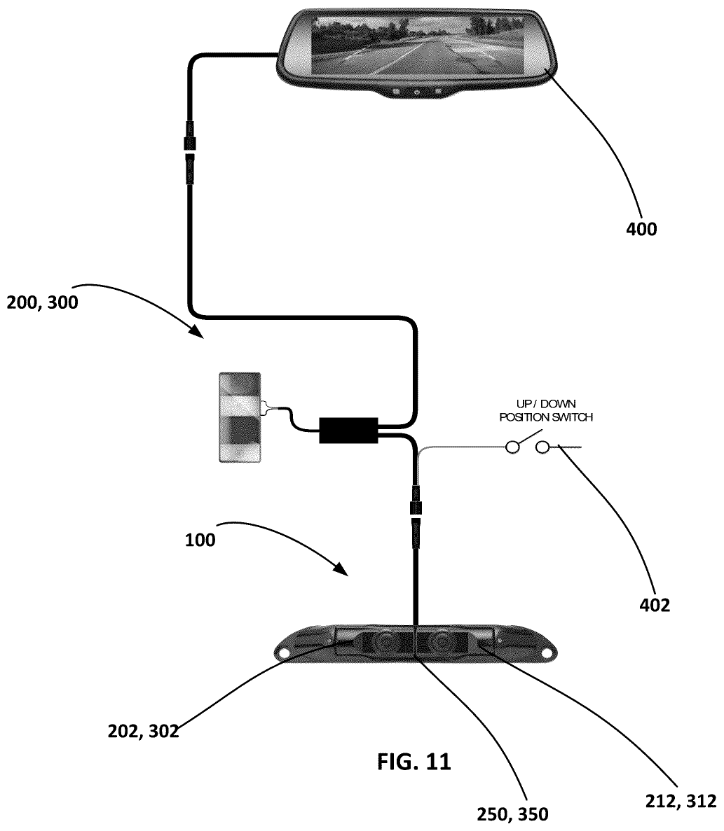

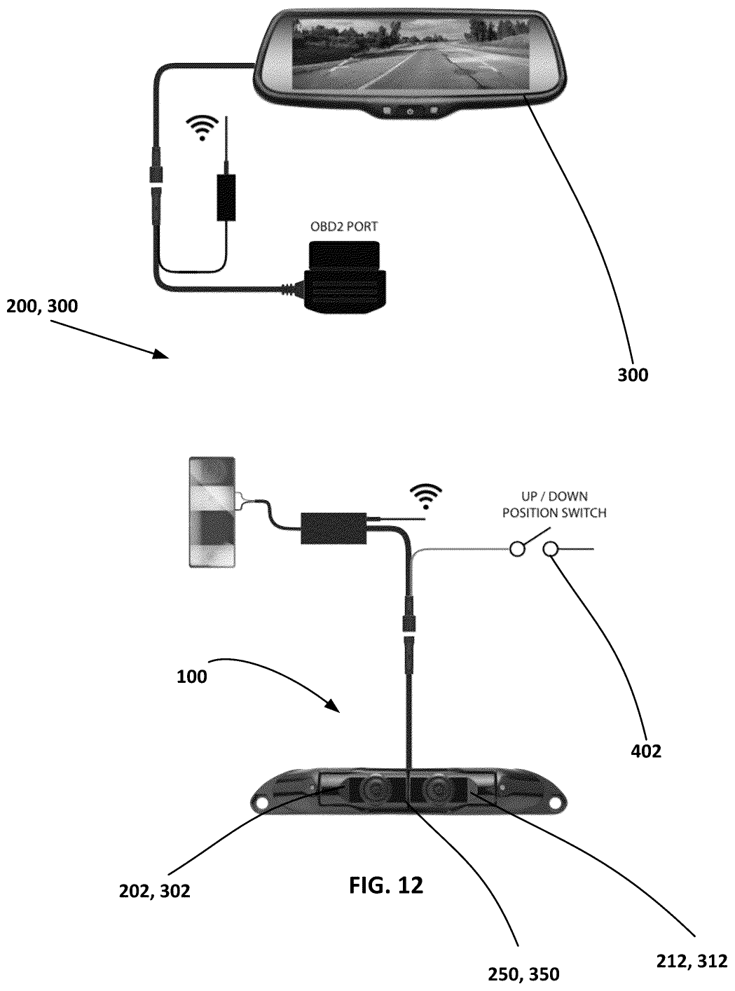

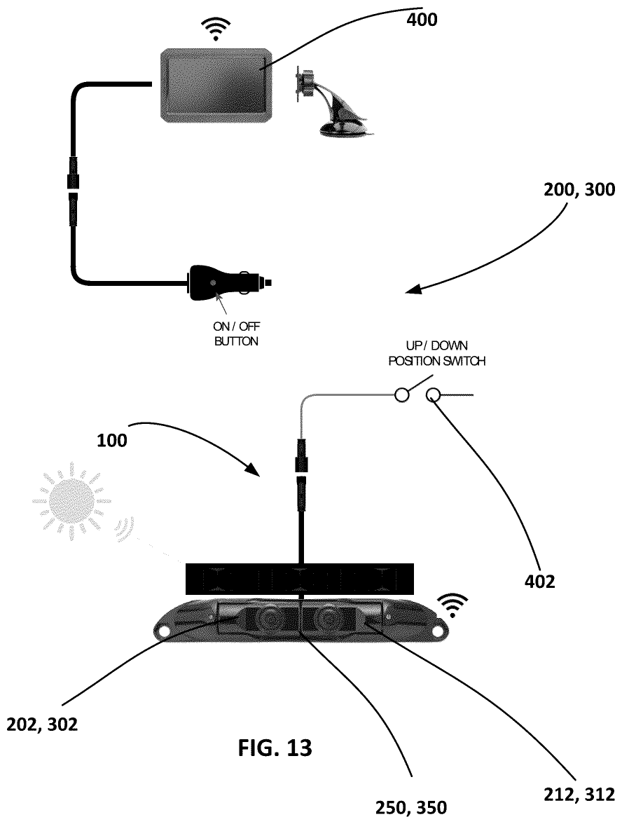

The sensing system 200, 300 and lift system overall 100 can be powered in multiple ways. In one example, the lift system 100 can include a rechargeable battery mounted on the lift system. The rechargeable battery can be charged through a separate charging device or it can be charged by connecting it to the automobile battery through the lift electrical harness and the existing hitch wiring on the automobile. In other examples the rechargeable battery could be powered by solar power as shown in FIG. 13. In still other examples the lift system 100 can be powered directly from the automobile or automobile battery through the lift electrical harness. As shown primarily in FIG. 11, the sensing system 200, 300 may include a wired connection including wires from the sensing system 200, 300 to the automobile to power the sensing system 200, 300, wires from the display 400 to the automobile to power the display 400, and wires from sensing system 200, 300 to the display 400 to communicate between the sensing system 200, 300 and the display 400. In some examples, communication between the display 400 and the sensing system 200, 300 may be a wireless communication system. As shown for example in FIG. 12, the sensing system 200, 300 may communicate with the display 400 through a wireless communication including for example Wi-Fi or Bluetooth communication.

Exemplary systems of power/wiring the lift system 100 are shown in FIGS. 11-13. As shown in FIG. 11, the sensing system 200, 300 is connected to the automobile battery through the lift electrical harness and the existing hitch wiring on the automobile. Additionally, it is connected to a display 400 in the rearview mirror of the automobile. FIG. 12 shows a system in which the sensing system 200 is connected to the automobile battery through the lift electrical harness and the existing hitch wiring on the automobile. The sensing system is wirelessly connected to the display 400 using any suitable wireless connection. FIG. 13 shows a system in which the sensing system 200 is powered by solar power and is wirelessly connected to the display 400. As shown in FIG. 13, the display 400 may be powered by connecting it to a cigarette lighter socket of the automobile or other suitable power source within the automobile.

The various embodiments described herein describe a lift and sensing system. It is also understood that in other embodiments, the various devices, components, and features of the lift and sensing system described herein may be constructed with similar structural and functional elements having different configurations, including different ornamental appearances. Still other benefits may be recognized by those skilled in the art. Accordingly, while the specific embodiments have been illustrated and described, numerous modifications come to mind without significantly departing from the spirit of the invention and the scope of protection is only limited by the scope of the accompanying claims.

What is claimed is:

1. A lift system configured to engage with a rear portion of an automobile, the lift system comprising:
a lift tower;
a platform which can be moved between an up position and a down position;
a first sensor housing engaged with the platform, the first sensor housing comprising:
a first camera;
a second sensor housing engaged with the platform, the second sensor housing comprising:
a second camera;
a display screen configured to display images from the first camera and the second camera; and
a switch, the switch configured to switch an image displayed on the display screen between the first camera when the platform is in the up position and the second camera when the platform is in the down position;
wherein the first sensor housing may be manually rotated to a first angle and the second sensor housing may be manually rotated to a second angle such that when the platform is in the up position the first camera is directed substantially rearward, and when the platform is in the down position the second camera is directed substantially rearward.

2. The lift system of claim 1 further comprising:
a sensor system housing configured to engage both of the first sensor housing and the second sensor housing.

3. The lift system of claim 2, wherein the first sensor housing is rotatably engaged with the sensor system housing.

4. The lift system of claim 3, wherein the second sensor housing is rotatably engaged with the sensor system housing.

5. The lift system of claim 4, wherein the first sensor housing is adjacent the second sensor housing.

6. The lift system of claim 1, wherein the switch is a mercury switch.

7. The lift system of claim 1, wherein the switch is a gyroscope switch.

8. The lift system of claim 1, wherein the switch is an accelerometer.

9. The lift system of claim 1, wherein the first sensor housing further comprises a first proximity sensor.

10. The lift system of claim 9, wherein the second sensor housing further comprises a second proximity sensor.

11. A lift system configured to engage with a rear portion of an automobile, the lift system comprising:
a lift tower;
a platform which can be moved between an up position and a down position;
a first sensor housing engaged with the platform, the first sensor housing comprising:
a first camera; and
a first proximity sensor;
a second sensor housing engaged with the platform, the second sensor housing comprising:
a second camera; and
a second proximity sensor;
a display screen configured to display images from the first camera and the second camera; and
a switch, the switch configured to switch an image displayed on the display screen between the first camera and first proximity sensor when the platform is in the up position and the second camera and second proximity sensor when the platform is in the down position;
wherein the first sensor housing and the second sensor housing may be rotated such that when the platform is in the up position the first camera and the first proximity sensor are directed substantially rearward, and when the platform is in the down position the second camera and the second proximity sensor are directed substantially rearward.

12. The lift system of claim 11 further comprising:
a sensor system housing configured to engage both of the first sensor housing and the second sensor housing.

13. The lift system of claim 12, wherein the first sensor housing is rotatably engaged with the sensor system housing.

14. The lift system of claim 13, wherein the second sensor housing is rotatably engaged with the sensor system housing.

15. The lift system of claim 14, wherein the first sensor housing is adjacent the second sensor housing.

16. A lift system configured to engage with a rear portion of an automobile, the lift system comprising:
a lift tower;
a platform which can be moved between an up position and a down position;
a sensor system housing engaged with a rear edge of the platform;
a first camera engaged with the sensor system housing;
a second camera engaged with the sensor system housing;
a display screen configured to display images from the first camera and the second camera; and
a switch, the switch configured to switch an image displayed on the display screen between the first camera when the platform is in the up position and the second camera when the platform is in the down position.

17. The lift system of claim 16, wherein the first camera is directed to a first angle and the second camera is directed to a second angle such that when the platform is in the up position the first camera is directed substantially rearward, and when the platform is in the down position the second camera is directed substantially rearward.

18. The lift system of claim 16, wherein the first camera is adjacent to the second camera.

19. The lift system of claim 16, further comprising at least one proximity sensor engaged with the sensor system housing.

20. The lift system of claim 16, wherein the first camera and the second camera are each rotatably engaged with the sensor system housing.
